(19) United States
(12) Patent Application Publication
(10) Pub. No.: US 2014/0209198 A1
(43) Pub. Date: Jul. 31, 2014

(54) EXHAUST SYSTEM AND APPARATUS FOR FABRICATING SEMICONDUCTOR DEVICE

(71) Applicant: Kabushiki Kaisha Toshiba, Minato-ku (JP)

(72) Inventor: Ryo KIKUCHI, Yokkaichi-shi (JP)

(73) Assignee: Kabushiki Kaisha Toshiba, Minato-ku (JP)

(21) Appl. No.: 14/166,042

(22) Filed: Jan. 28, 2014

(30) Foreign Application Priority Data
Jan. 28, 2013 (JP) 2013-013704

(51) Int. Cl. F15D 1/00

(52) U.S. Cl. CPC F15D 1/0015
USPC 137/808

(57) ABSTRACT

An aspect of one embodiment, there is provided an exhaust system includes a vacuum pump exhausting first gas, a trap bottle having a cylindrical shape, a sidewall of the trap bottle being configured to move in a circumference direction, and a first pipe connecting between the vacuum pump and the trap bottle, the first pipe having a tilt angle in an axis direction of the cylindrical shape, the first gas flowing in the first pipe from the vacuum pump to the trap bottle.

### CROSS REFERENCE TO RELATED APPLICATION

This application is based upon and claims the benefit of priority from prior Japanese Patent Application No. 2013-013704, filed on Jan. 28, 2013, the entire contents of which are incorporated herein by reference.

### FIELD

Exemplary embodiments described herein generally relate to an exhaust system and apparatus for fabricating a semiconductor device.

### BACKGROUND

Exhaust gas exhausted from an apparatus for manufacturing a semiconductor device, such as a film processing apparatus or the like, may be changed to be a powder in cooling.

Such powder may be necessary to be trapped in a trapping bottle because the powder is deposited on a pipe of the apparatus in an exhausting process.

### BRIEF DESCRIPTION OF THE DRAWINGS

FIG. 1 is a schematic diagram showing an exhaust system according to a first embodiment;

FIGS. 2A and 2B are cross-sectional views showing a trap unit according the first embodiment;

FIGS. 3A and 3B are cross-sectional views showing a trap unit according a second embodiment;

FIGS. 4A and 4B are cross-sectional views showing a trap unit according a third embodiment;

FIGS. 5A and 5B are cross-sectional views showing a trap unit according the third embodiment;

FIGS. 6A and 6B are cross-sectional views showing a trap unit according a fourth embodiment.

### DETAILED DESCRIPTION

An aspect of one embodiment, there is provided an exhaust system includes a vacuum pump exhausting first gas, a trap bottle having a cylindrical shape, a sidewall of the trap bottle being configured to move in a circumference direction, and a first pipe connecting between the vacuum pump and the trap bottle, the first pipe having a tilt angle in an axis direction of the cylindrical shape, the first gas flowing in the first pipe from the vacuum pump to the trap bottle.

An aspect of another embodiment, there is provided an apparatus for fabricating a semiconductor device, the apparatus including a chamber, a first vacuum pump connected to the chamber, an exhaust system connected to the first vacuum pump, the exhaust system including, a second vacuum pump configured to exhausting a first gas, a trap bottle having a cylindrical shape, a sidewall of the trap bottle being configured to move in a circumference direction, a first pipe connecting between the second vacuum pump and the trap bottle, the first pipe having a tilt angle in an axis direction of the cylindrical shape, the first gas flowing in the first pipe from the second vacuum pump to the trap bottle.

Embodiments will be described below in detail with reference to the attached drawings mentioned above. Throughout the attached drawings, similar or same reference numerals show similar, equivalent or same components, and the description is not repeated.

### First Embodiment

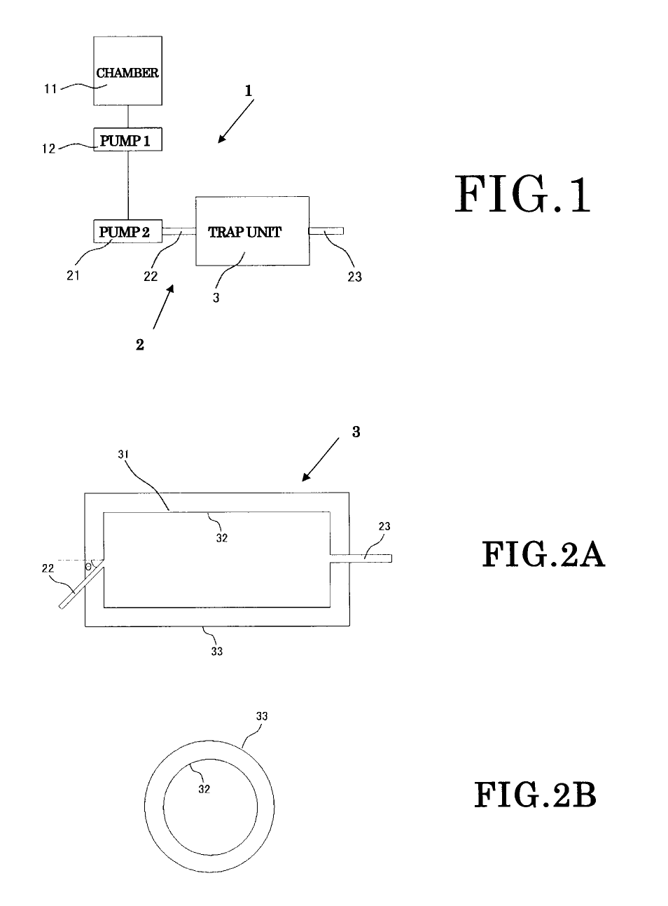

FIG. 1 is a schematic diagram showing an apparatus for fabricating a semiconductor device and an exhaust system according to a first embodiment. An apparatus for fabricating a semiconductor device 1 includes a chamber 11, a turbo molecular pump 12 connected to the chamber 11 and an exhaust system 2 connected to the turbo molecular pump. The apparatus 1 is a film processing apparatus, dry etching apparatus or the like, for example. A semiconductor wafer is processed in the chamber 11 by using gas. The gas used in the chamber is exhausted from the chamber 11 by the turbo molecular pump 12, for example.

The exhaust system 2 includes a dry pump 21 (pump 2) as a vacuum pump. The dry pump 21 is connected to the turbo molecular pump 12 in the apparatus for fabricating a semiconductor device 1. The dry pump 21 sends the gas exhausted from the chamber to downstream. The gas is exhausted from the dry pump 21 to the trap unit 3 through an inflow pipe 22. In the trap unit 3, powders in the exhausted gas are trapped. The exhaust gas is exhausted from the trap unit 3 through an outflow pipe 23.

FIGS. 2A and 2B are cross-sectional views showing the trap unit 3 according the first embodiment. FIG. 2A is a cross-sectional view from a perpendicular view to an axis direction of a trap bottle 31 in the trap unit 3 and FIG. 2B is a cross-sectional view from the perpendicular view to the axis direction of the trap bottle 31 having a sidewall 32 with a cylindrical shape.

The trap bottle 31 having the sidewall 32 with the cylindrical shape is provided in the trap unit 3. A cylindrical direction in the cylindrical shape is set in an axis direction of the trap bottle 31. The circular shape in the cylindrical shape is not restricted to an ideal circle but includes an ellipsoidal circle, which has non-constant radius, or the like.

The sidewall 32 of the trap bottle 31 can slidably move to a circumference direction of the cylindrical shape.

An outer wall 33 of the trap unit 3 is provided outside of the trap bottle 31 to cover the trap bottle 31. A space is provided between the sidewall 32 of the trap bottle 31 and the outer wall 33 of the trap unit. Gas other than the exhaust gas can be flowed in the space.

The inflow pipe 22 is connected to the trap bottle 31 at an inflow side of the exhaust gas. The inflow pipe 22 with a tilt angle is connected to the trap bottle 31 in the axis direction of the trap bottle 31. When an angle of inflow pipe 22 in the axis direction of the trap bottle 31 is set as an inflow angle θ, as shown FIG. 2, the tilt is defined as 0°<0≦90°. The inflow pipe 22 can be connected to an edge surface with a circle shape in a cylindrical portion of the trap bottle 31 or to the sidewall 32 of the cylinder shape.

The outflow pipe 23 is connected to the trap bottle 31 at an outflow side of the exhaust gas. The outflow pipe 23 is favorably to have not a tilt in the axis direction of the trap bottle 31.

A simulation with respect to the gas flow in the trap unit 3 is conducted when the inflow pipe 22 is provided on the sidewall 32 of the trap bottle 31 with the inlet angle θ. Conditions of the simulation are set as follows. Nitrogen gas is used as the exhaust gas with a flow amount of 50-500 sccm. A diameter of the inflow pipe 22 is set to be 27 mm. An inflow pressure is set to be 150-300 mTorr. The trap bottle 31 has a length of 250 mm in the cylindrical direction and a cylinder diameter of 60 mm.

A result of the simulation reveals that a vortex is generated in the trap bottle 31 when the inflow pipe 32 is tilted to be connected to the trap bottle 31, so that the exhaust gas is filled in the trap bottle 31. In such a manner, powder included in the sidewall 32 of the trap bottle 31 is averagely deposited inside the trap bottle 31.

As mentioned above, in the exhaust system 2 of the first embodiment, the inflow pipe 22 is tilted in the axis direction of the trap bottle 31 to be connected to the trap bottle 31. Accordingly, the vortex of the exhaust gas is generated in the trap bottle 31, so that the powder included in the sidewall 32 of the trap bottle 31 is averagely deposited inside the trap bottle 31. In other words, the exhaust system 2 having no clog and higher life can be provided.

### Second Embodiment

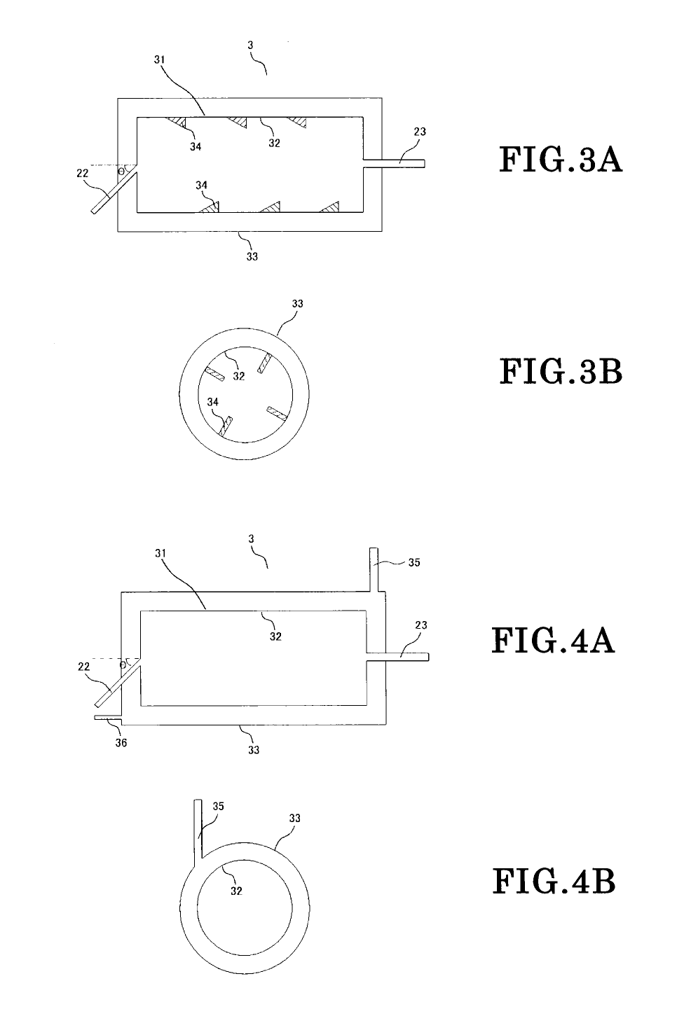

A trap unit according to a second embodiment is described by using FIGS. 3A and 3B. Throughout a constitution of an exhaust system in the second embodiment as shown in FIGS. 3A and 3B, similar or same reference numerals with that of the exhaust system in the first embodiment described in FIGS. 2A and 2B show similar, equivalent or same components, and the description is not repeated. A different point of the second embodiment from the first embodiment is that a fin 34 is provided on the sidewall 32 of the trap bottle 31 in FIGS. 2A and 2B.

The fin 34 is provided on the sidewall 32 of the trap bottle 31 in the exhaust system according to the second embodiment as shown in FIGS. 3A and 3B. A plurality of the fins 34 can be provided as shown in FIGS. 3A and 3B.

A surface area of the sidewall 32 in the trap bottle 31 is increased by the fin 34 so that a life of the exhaust system 2 can be extended. As shown in FIG. 3A, the fin 34 has a triangular shape which becomes higher in a gas stream direction from a view point of a perpendicular direction in an axis direction of the trap bottle 31, for example. In such a case, the exhaust gas in the trap bottle 31 is exhausted as a vortex state along a surface of the fin 34. Therefore, powder included in the exhaust gas can be averagely deposited inside the trap bottle 31. Further, the cross section of the fin 34 is not restricted to triangular but may be square in FIG. 3A.

Collision of the exhaust gas with the vortex state to the sidewall of the fin 34 can lead to rotate the sidewall 32 which is rotatable in a circumstance direction of the trap bottle 31 through the fins 34. In such a manner, a vortex stream of the exhaust gas is enhanced so that the powder included in the exhaust gas can be averagely deposited on the sidewall 32 of the trap bottle 31.

### Third Embodiment

A trap unit according a third embodiment is described by using FIGS. 4A and 4B. Throughout a constitution of an exhaust system in the second embodiment as shown in FIGS. 4A and 4B, similar or same reference numerals with that of the exhaust system in the first embodiment described in FIGS. 2A and 2B show similar, equivalent or same components, and the description is not repeated. A different point of the third embodiment from the first embodiment is that a gas inflow pipe 35 and a gas outflow pipe 36 are connected to the outer wall 33 in FIG. 2.

In an exhaust system 2 according to the third embodiment, a gas inflow pipe 35 and a gas outflow pipe 36 are provided on an outer wall 33 of a trap unit 3 as shown in FIG. 4. The gas inflow pipe 35 is connected to the outer wall 33 of the trap unit 3 in nearly perpendicular direction to the axis direction of a trap bottle 31, for example. The gas outflow pipe 36 is connected to the outer wall 33 of the trap unit 3 in nearly horizontal direction to the axis direction of the trap bottle 31, for example. The gas inflow pipe 35 and the gas outflow pipe 36 are connected to one end and the other end, respectively. The gas inflow pipe 35 and the gas outflow pipe 36 are connected to an outlet side and an inlet side of the exhaust gas in the trap unit 3, respectively, for example.

The gas is inlet in a space surrounded by the sidewall 32 of the trap bottle 31 and the outer wall of the trap unit 3 from the gas inflow pipe 35. The gas inlet from the gas inflow pipe 35 is inert gas such as cooled nitrogen or the like, for example. The trap unit 3 is cooled by the cooled gas to be able to improve a trap efficiency of the powder.

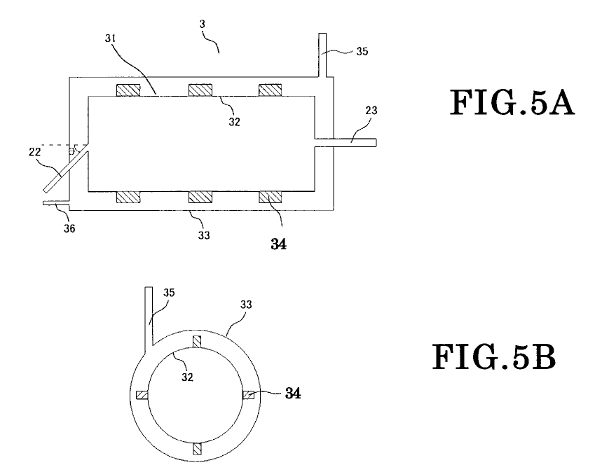

As shown in FIG. 5, the fins 34 can be provided on the outside of the sidewall 32 of the trap bottle 31. In such a manner, the vortex gas stream inlet to the trap bottle 31 is collided to the fins 34 to rotate trap bottle 31 which is rotatable in a circumstance direction of the trap bottle 31 through the fins 34. As a result, the vortex stream of the exhaust gas is enhanced so that the powder included in the exhaust gas can be averagely deposited on the sidewall 32 of the trap bottle 31.

### Fourth Embodiment

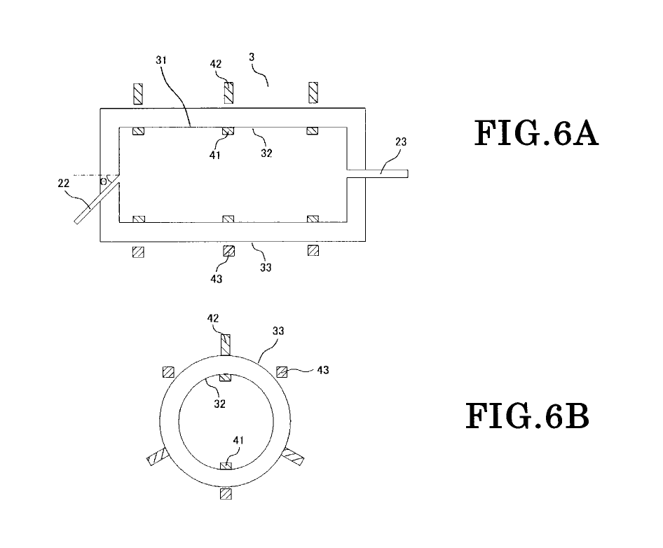

A trap unit according a fourth embodiment is described using FIGS. 6A and 6B. Throughout a constitution of an exhaust system in the fourth embodiment as shown in FIGS. 6A and 6B, similar or same reference numerals with that of the exhaust system in the second embodiment described in FIG. 3 show similar, equivalent or same components, and the description is not repeated. A different point of the fourth embodiment from the second embodiment is that the sidewall 32 of the trap bottle 31 in FIGS. 3A and 6B is rotated by an electrical mechanism instead of rotation by the fins 34.

FIGS. 6A and 6B are schematic views showing a trap unit according the fourth embodiment. A pair of magnetic bodies 41 corresponding to N-pole and S-pole is provided on a sidewall 32 of a trap bottle 31. An electromagnetic coil 42 and a Hall element 43 are provided on a periphery of the trap unit 3 to surround the trap unit 3. The electromagnetic coil 42 can exchange N-pole and S-pole of the magnetic body 41 of the trap bottle 31. The Hall element 43 can detect magnetic pole to transform to an electrical signal.

A driver (not shown) is provided to electrically connect the electromagnetic coil 42 and the Hall element 43. A controller (not shown) provided to electrically connect the driver and a main body of a semiconductor manufacturing apparatus (not shown). As shown in FIG. 1, after the semiconductor manufacturing apparatus 1 start up, a semiconductor wafer can be processed in a chamber 11. In such a case, the electromagnetic coil 42 and the Hall element 43 are controlled by the controller and the driver to rotate the sidewall 32 of the trap bottle 31. In such a manner, a vortex stream of the exhaust gas is enhanced so that the powder included in the exhaust gas can be averagely deposited on the sidewall 32 of the trap bottle 31.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An exhaust system, comprising:
a vacuum pump exhausting first gas;
a trap bottle having a cylindrical shape, a sidewall of the trap bottle being configured to move in a circumference direction; and
a first pipe connecting between the vacuum pump and the trap bottle, the first pipe having a tilt angle in an axis direction of the cylindrical shape, the first gas flowing in the first pipe from the vacuum pump to the trap bottle.

2. The exhaust system of claim 1, wherein
the tilt angle is set between 0 ° and 90 °.

3. The exhaust system of claim 1, wherein
the trap bottle includes a plurality of fins inside of the sidewall.

4. The exhaust system of claim 3, wherein
Each of the fins has a triangle shape.

5. The exhaust system of claim 3, wherein
the trap bottle is configured to be rotatable around the axis direction.

6. The exhaust system of claim 1, further comprising:
an outer wall is provide outside the trap bottle to surround the sidewall of the trap bottle, wherein
a second gas is configured to be flowed in a space surround by the sidewall of the trap bottle and the outer wall.

7. The exhaust system of claim 6, wherein
the second gas is flowed in nearly perpendicular to the axis direction of the cylindrical shape.

8. The exhaust system of claim 6, wherein
the second gas is an inert gas which is cooled.

9. The exhaust system of claim 1, further comprising:
a plurality of fins is provided outside of a sidewall of the trap bottle.

10. The exhaust system of claim 9, wherein
the trap bottle is configured to be rotatable around the axis direction.

11. The exhaust system of claim 1, wherein
the trap bottle is configured to be rotatable around the axis direction by electrical control.

12. The exhaust system of claim 11, wherein
the electrical control is conducted by an electromagnetic method.

13. The exhaust system of claim 1, further comprising:
a pair of magnetic bodies on the sidewall of the trap bottle, and an electromagnetic coil and a Hall element provided outside the trap unit,
wherein the electromagnetic coil exchanges polarity of the magnetic body, the Hall element detects magnetic pole to exchange an electrical signal so that the trap bottle is rotated.

14. An apparatus for fabricating a semiconductor device, the apparatus comprising, a chamber, a first vacuum pump connected to the chamber, an exhaust system connected to the first vacuum pump, the exhaust system comprising:
a second vacuum pump configured to exhausting a first gas;
a trap bottle having a cylindrical shape, a sidewall of the trap bottle being configured to move in a circumference direction;
a first pipe connecting between the second vacuum pump and the trap bottle, the first pipe having a tilt angle in an axis direction of the cylindrical shape, the first gas flowing in the first pipe from the second vacuum pump to the trap bottle.

15. The apparatus for claim 14,
wherein the trap bottle includes a plurality of fins inside of the sidewall.

16. The apparatus for claim 14, further comprising:
an outer wall is provide outside the trap bottle to surround the sidewall of the trap bottle, wherein
a second gas is configured to be flowed in a space surround by the sidewall of the trap bottle and the outer wall.

17. The apparatus for claim 16, further comprising:
a plurality of fins is provided outside of a sidewall of the trap bottle.

18. The apparatus for claim 16, wherein
the trap bottle is configured to be rotatable around the axis direction by electrical control.

19. The apparatus for claim 14, further comprising:
a pair of magnetic bodies on the sidewall of the trap bottle, an electromagnetic coil and a Hall element provided outside the trap unit,
wherein the electromagnetic coil exchanges polarity of the magnetic body, the Hall element detects magnetic pole to exchange to an electrical signal so that the trap bottle is rotated.
